(19) United States
(12) Patent Application Publication
(10) Pub. No.: US 2006/0220955 A1
(43) Pub. Date: Oct. 5, 2006

(54) Geographic marking device with RFID transponder

(76) Inventor: Jeffery Allen Hamilton, Broomfield, CO (US)

Correspondence Address: Wagner Murabito & Hao LLP, 123 Westridge Drive, Watsonville, CA, 95076, US

(21) Appl. No.: 11/097,425

(22) Filed: Mar. 31, 2005

(51) Int. Cl. G01S 5/14

(52) U.S. Cl. 342/357.13

(57) ABSTRACT

Embodiments of the present invention recite a geographic marking device and a data storage device coupled therewith for storing information associated with a geographic location at which the geographic marking device is located. In embodiments of the present invention, the information may comprise geographic position data of the geographic marking device as well as additional information about an object which is substantially fixed at the geographic location. In another embodiment of the present invention, a geographic data system is recited comprising the geographic marking device described above and a portable electronic device for accessing information stored thereon.

### FIELD OF THE INVENTION

Embodiments of the present invention are related to the field of storing and accessing geographic position data.

### BACKGROUND OF THE INVENTION

Surveyors frequently use a variety of devices to mark geographic locations. For example, when surveying the boundaries of a property, the surveyor starts at a first known location at which the geographic coordinates have already been determined. From there, the surveyor measures the angle and distance to a series of points which delineate the boundaries of the property being surveyed. The surveyor will drive a nail or other geographic marker into the earth at those points to mark them. The marker may have a washer or other device attached which may include information such as the survey case number, the surveyor's license number, and a serial number of the individual marker.

However, these markers, also referred to as pegs, nails, hubs, rods, or monuments, can be moved or become difficult to find. For example, after the marker is driven into the ground, it can become covered with dirt and/or plant growth. It may also become driven into the ground further due to someone stepping on, or driving over the marker. Alternatively, someone may intentionally move the marker in order to alter the boundaries of their property. As a result, not only is it difficult to find these markers after the survey has been performed, but there is no assurance that the markers are still at the same location as when the marker was originally emplaced.

As a result, when a subsequent survey of the property is performed, the surveyor accesses a record of the previous survey from the local government to determine where the boundaries of the property are. The surveyor then tries to find the markers emplaced in the previous survey to confirm the boundary lines. However, if the surveyor cannot find the markers, or if the markers have been moved, the record of survey from the previous survey does not reconcile with the current position of the markers and the surveyor then has to reconstruct the boundary lines and place new markers, etc. Additionally, when accessing data from a previous survey, recording data from a current survey, it is possible to incorrectly transcribe data.

### SUMMARY OF THE INVENTION

Accordingly, a need exists for geographic marking device which has embedded geographic position information. While meeting the above stated need, it would be advantageous to be able to write additional information to the geographic marking device to assist in, for example, asset management.

Embodiments of the present invention recite a geographic marking device and a data storage device coupled therewith for storing information associated with a geographic location at which the geographic marking device is located. In embodiments of the present invention, the information may comprise geographic position data of the geographic marking device as well as additional information about an object which is substantially fixed at the geographic location. In another embodiment of the present invention, a geographic data system is recited comprising the geographic marking device described above and a portable electronic device for accessing information stored thereon.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a schematic diagram of an exemplary geographic data system in accordance with embodiments of the present invention.

FIG. 2 is a schematic diagram of an exemplary geographic data interrogator in accordance with embodiments of the present invention.

FIG. 3 is a flowchart of a method for accessing geographic information in accordance with embodiments of the present invention.

### DETAILED DESCRIPTION OF THE PREFERRED EMBODIMENT

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

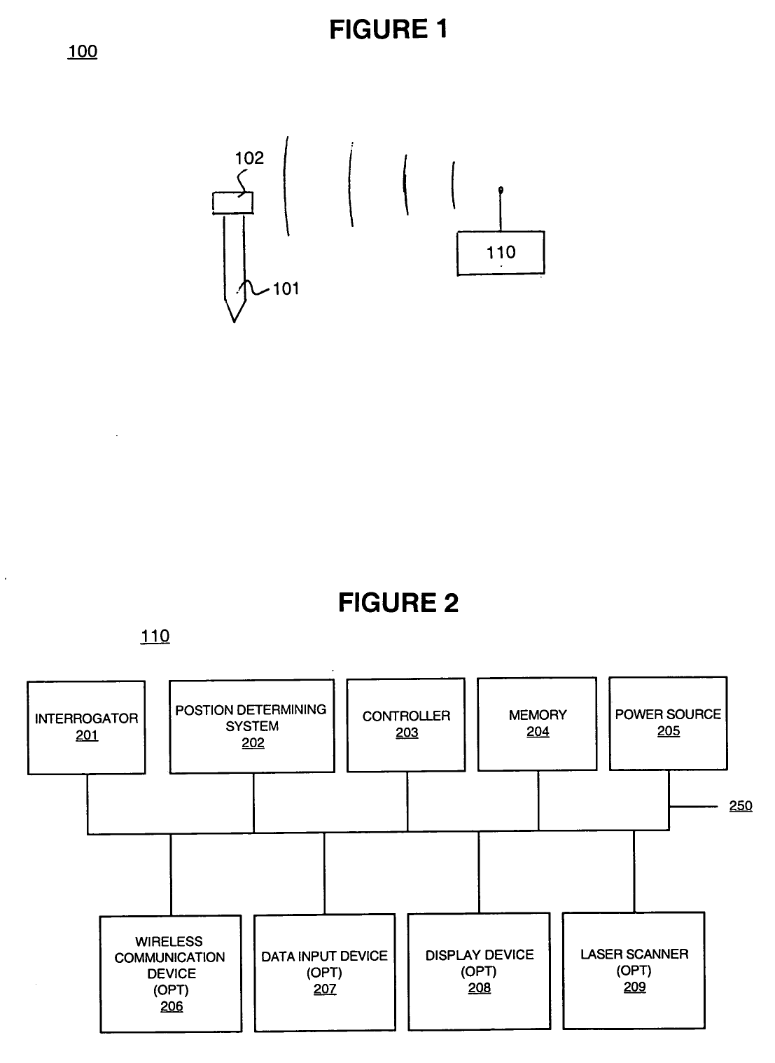

FIG. 1 is a schematic diagram of an exemplary geographic data system in accordance with embodiments of the present invention. In the embodiment of FIG. 1, a geographic marking device 101 is coupled with a data storage device 102. Also shown in FIG. 1 is a geographic data interrogator 110 for accessing data stored on data storage device 102 and/or for writing data to data storage device 102.

In embodiments of the present invention, geographic marking device 101 may be a rod, nail, or other device typically used by surveyors to mark a particular point on or near the surface of the earth. However, in other embodiments of the present invention, geographic marking device 101 may comprise a device which facilitates attaching or embedding data storage device 102 onto or within an object.

In embodiments of the present invention, data storage device 102 comprises a radio frequency identification (RFID) tag. RFID is a type of automatic identification technology which typically uses radio waves to transmit the identity of a person or object. A typical RFID tag (e.g., 102) comprises a microchip which is coupled with an antenna and is mounted on a substrate. For the purposes of the present invention, data storage device 102 will be referred to as an RFID tag. However, embodiments of the present invention are not limited to this configuration alone and may use other data storage devices and transmission apparatus for storing geographic position data.

Passive RFID tags do not have a power source or transmitter. Instead, they gather electromagnetic energy from an interrogating device (e.g., geographic data interrogator 110). The microchip within the RFID tag then uses this energy to change the load on the antenna to reflect back an altered signal which conveys information to the interrogating device.

Active RFID tags have a transmitter and a power source such as a battery. The power source is used to run the circuitry of the RFID tag and to transmit a signal to an interrogating device. Active RFID tags may either be transponders, which “wake up” when they detect a signal from an interrogating device, or beacons which emit a signal at pre-set intervals.

Semi-active RFID tags draw power from a power source to run the circuitry of the RFID tag but communicate by drawing power from the electromagnetic energy emitted by the interrogating device. Typically, active and semi-active RFID tags cost more than passive RFID tags but have a greater transmitting range. In embodiments of the present invention, RFID tag 102 may comprise an active, semi-active, or passive RFID tag.

RFID tags may also be classified in the way data is stored, or accessed. Read only RFID tags have information stored on them during the manufacturing process which cannot be changed or appended in the field. Read/write RFID tags information can be added to, or written over, existing information on the tag. Typically, a serial number written on the tag at the time of manufacture cannot be written over. Additionally, some information that is subsequently written to the tag may be locked to prevent overwrite. Write once, read only (WORM) tags can only be written to once, and thereafter can only be read. In embodiments of the present invention RFID tag 102 may be a read only RFID tag, read/write RFID tag, or a WORM RFID tag.

In embodiments of the present invention, geographic data interrogator 110 may be, for example, a handheld electronic device, an optical survey range pole, a geographic information system (GIS) data collector, a three dimensional laser scanner, or a mobile geographic data collector. In one embodiment, geographic data interrogator 110 is simply a data collector for accessing the data stored on RFID tag 102. In other embodiments, geographic data interrogator 110 is also for writing information to RFID tag 102 such as geographic position data.

Embodiments of the present invention are advantageous over conventional geographic marking devices because they allow a surveyor or other user to compare the geographic position data stored on RFID tag 102 with a field measurement of the geographic location of the tag. By comparing the two, a surveyor or other user can determine whether geographic marking device 101 has been moved from its previous position. Additionally, the surveyor or other user can access other information stored on RFID tag 102 which may be useful.

FIG. 2 is block diagram of an exemplary geographic data interrogator 110 in accordance with embodiments of the present invention. In the embodiment of FIG. 2, geographic data interrogator 110 comprises an RFID interrogator 201 coupled with a positioning determining system 202, a controller 203, a memory 204, and a power source 205 via a bus 250. In embodiments of the present invention, geographic data interrogator 110 further comprises an optional wireless communication system 206, an optional data input device 207, an optional display device 208, and an optional laser scanning device 209 which are coupled with bus 250.

Interrogator 201 is for wirelessly communicating with RFID tag 102 and for accessing information stored thereon Furthermore, interrogator 201 is for wirelessly conveying data (e.g., geographic position data) to RFID tag 102 which may be stored thereupon.

Position determining system 202 is for determining the location of geographic data interrogator 110. For the purposes of the present invention, the term “geographic position” means the determining in at least two dimensions (e.g., latitude and longitude), the location of geographic data interrogator 110. In embodiments of the present invention, position determining system 202 comprises a GPS receiver and a Global Positioning System (GPS) antenna 210. In one embodiment, position determining system 202 is a satellite based position determining system and receives navigation data from satellites via antenna 210. Examples of satellite based position determining systems include the global positioning system (GPS) navigation system, a differential GPS system, a real-time kinematic (RTK) system, a networked RTK system, etc. While the present embodiment recites these position determining systems specifically, it is appreciated that embodiments of the present invention are well suited for using other position determining systems as well such as ground-based position determining systems, or other satellite-based position determining systems such as the GLONASS system, or the Galileo system currently under development.

Controller 203 is for receiving and executing commands for determining a geographic location of geographic data interrogator 110 and for sending/receiving information to or from geographic marking device 100. Controller 203 is also for converting from a first coordinate system which describes the geographic coordinates of geographic marking device 101 to a second coordinate system. For example, survey data is often recorded using a local coordinate system which is unique to the state, county, or municipal region in which the survey is conducted. As a result, the geographic position data stored upon RFID tag 102 may also be recorded using the local coordinate system. However, position determining system 202 may not be operable for determining the geographic position of geographic data interrogator 110 using this local coordinate system. Therefore, in embodiments of the present invention, controller 203 may execute software instructions for converting from the local coordinate system to another coordinate system.

Memory 204 is for storing instructions and position information which has been determined by position determining component 202. This allows embodiments of geographic data interrogator 110 to, for example, store a log of positions it has been at over a period of time

Power source 205 is for providing power to geographic data interrogator 110. In one embodiment, power source 205 is a power source such as a battery or plurality of batteries (e.g., 4 alkaline AA batteries). However, while the present embodiment recites a battery or batteries, the present invention is well suited for utilizing other power sources as well. In embodiments of the present invention, power source 205 may be coupled with an external power source such as the electrical system of vehicle. For example, power source 205 may be hard wired to the electrical system of a vehicle, or may be coupled to an accessory outlet or cigarette lighter outlet in the vehicle using an adapter plug.

Wireless communications component 206 is for transmitting and receiving wireless messages (e.g., data and commands). In one embodiment, wireless communications component 206 is comprised of a cellular wireless antenna and a cellular wireless modem. The use of a cellular communications system allows a user of geographic data interrogator 110 to access records, maps, aerial photos, software updates, etc. via the Internet. In another embodiment, wireless communications component 206 may comprise, for example, a two-way radio system, a Bluetooth wireless communication system, etc.

In embodiments of the present invention, data input device 207 provides additional input/output capabilities to geographic data interrogator 110. In one embodiment, data input device 207 comprises an alpha-numeric keyboard for inputting data, selections, updates, etc. In embodiments of the present invention, data input device 207 may also comprise a device drive which allows reading a media storage device such as a compact disk (CD), a digital versatile disk (DVD), a memory stick, or the like. This allows, for example, integrating data from various software applications such as mapping software in order to facilitate controlling geographic data interrogator 110. For example, the geographic position of survey markers and/or property boundaries can be easily input into geographic data interrogator 110 to expedite a survey. Data input device 207 may also comprise a cursor control device which allows a user to dynamically signal the two dimensional movement of a visible symbol (cursor) on a display screen of display device 207. Many implementations of cursor control devices are known in the art including a trackball, mouse, touch pad, joystick, or special keys on data input device 207 which are capable of signaling movement of a given direction or manner displacement.

In embodiments of the present invention, optional display device 208 of may be a liquid crystal device, a touch screen display, or other display device suitable for displaying images and alpha-numeric characters recognizable to a user.

In embodiments of the present invention, laser scanning device 209 is a three dimensional (3-D) laser scanning device. 3-D laser scanning devices are used to determine the azimuth and distance from a fixed point (e.g., the 3-D laser scanner) and a plurality of points, also known as a “point cloud,” which define an object. For example, the 3-D laser scanner can be set up in front of a building and be used to create a mapping of various points on the building. This data can then be used, for example, to create a model of the building.

In embodiments of the present invention, geographic data interrogator 110 is a handheld portable electronic device. For example, geographic data interrogator 110 may be implemented as a data reader used in field surveys. In another embodiment, geographic data interrogator 110 may be wired to a vehicle electronic system as described above. In another embodiment, geographic data interrogator 110 may be implemented in a three dimensional laser scanner. In other embodiments, geographic data interrogator 110 is implemented as a component of an optical surveying system, a real-time kinematic (RTK) roving receiver, or a geographic information system (GIS) data collector. In another embodiment, geographic data interrogator 110 is implemented as an electronic distance measuring (EDM) component.

In operation, a user can quickly access geographic position data using system 100. For example, a surveyor can use geographic data reader 110 to access data stored on RDID tag 102. Using geographic data reader 110, the surveyor can then compare this data with a measurement of the present geographic position of geographic position marker 101 to determine whether geographic position marker 101 has been moved. Additionally, because RFID tag 102 can be used to store other information, the surveyor can access other information about the previously performed survey such as the surveyor's name, license number, telephone number, the case number of the previous survey, etc. The surveyor could then wirelessly access the files of the local land information system to access that case and view it upon geographic data interrogator 110. The surveyor could also view a map of the previous survey upon display device 208 to facilitate finding other geographic marker devices which were emplaced during the previous survey.

Embodiments of the present invention may also incorporate a system for locating a target point having known coordinates. One such system is described in U.S. Pat. No. 6,304,210 titled Location and Generation of High Accuracy Survey Control Marks Using Satellites by Michael T. Allison, Mark Nichols, and James L. Sorden, assigned to Trimble Navigation Ltd., of Sunnyvale, Calif., and incorporated as reference herein in its entirety. In this patent, Allison et al. disclose a system in which a first position determining device is situated at a first known position and transmits the geographic coordinates of the first position and of a target point which is displaced from the first position determining device. A roving position determining device uses these geographic coordinates to find the target point. Embodiments of the present invention may use this system to guide a surveyor to a previously placed geographic marker, or to facilitate determining the location at which a geographic marking device (e.g., 101) is to be placed.

In another embodiment of the present invention, geographic data interrogator 110 is operable to determine the signal strength from RFID tag 102 and for generating instructions (e.g., direction and/or map displays) for guiding a user of geographic data interrogator 110 to RFID tag 102. This facilitates finding previously placed geographic markers.

Embodiments of the present invention may also be used in asset management when the incorporation of geographic data is desired. For example, in the field of forest management, RRID tag 102 may be embedded within a tree. Occasionally, a user of geographic data interrogator 110 can write information to the RFID tag such as the date, tree height/diameter, site information, etc to establish a chain of custody of that tree.

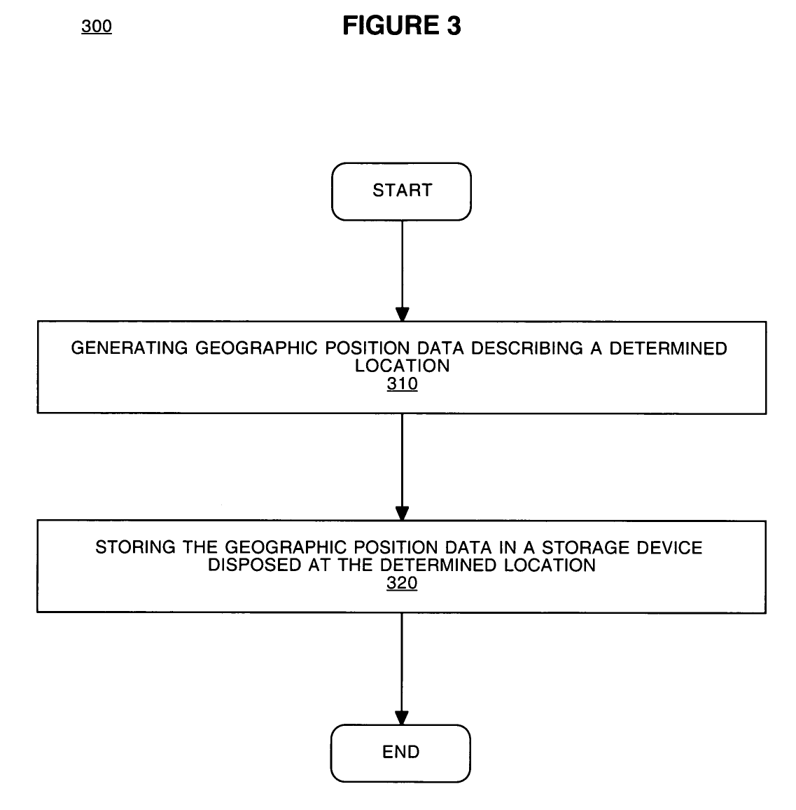

FIG. 3 is a flowchart of a method for accessing geographic information in accordance with embodiments of the present invention. In step 310 of FIG. 3, geographic position data describing a determined location is generated. In embodiments of the present invention, the geographic position data may be generated at the particular determined position, and stored upon the geographic marking device 101 when geographic marking device 101 is emplaced. In another embodiment, the geographic position data of the determined location is determined at a position other than the determined position. For example, the geographic position data for a plurality of geographic marking devices may be determined prior to taking the geographic marking devices to the particular location at which they will be emplaced.

In step 320 of FIG. 3, the geographic position data generated in step 310 is stored in a data storage device which is disposed at said determined location. As described above, embodiments of the present invention facilitate storing geographic position data upon a geographic marking device.

The preferred embodiment of the present invention, a geographic marking device with RFID, is thus described. While the present invention has been described in particular embodiments, it should be appreciated that the present invention should not be construed as limited by such embodiments, but rather construed according to the following claims.

What is claimed is:

1. A device for providing geographic information, said device comprising:
a geographic marking device; and
a data storage device coupled with said geographic marking device for storing information associated with a geographic location at which said geographic marking device is located.

2. The device of claim 1 wherein said geographic marking device comprises a surveyor's marker.

3. The device of claim 1 wherein said data storage device conveys said information via a wireless communication.

4. The device of claim 3 wherein said data storage device comprises:
a radio frequency identification (RFID) tag.

5. The device of claim 1 wherein said information further comprises:
information about an object which is at said geographic location.

6. The device of claim 1 wherein said information further comprises:
information identifying said geographic marking device.

7. A geographic data system comprising:
a geographic marking device comprising a data storage device for storing information associated with a geographic location at which said geographic marking device is located; and
an electronic device for accessing said information from said data storage device.

8. The geographic data system of claim 7 wherein said geographic marking device comprises a surveyor's marker.

9. The geographic data system of claim 7 wherein said electronic device comprises a wireless device selected from the group consisting of:
a handheld electronic device, an optical surveying component, an optical survey range pole, a real-time kinematic (RTK) roving receiver, a geographic information system (GIS) data collector, a three dimensional laser scanner, an electronic distance measuring (EDM) component, and a mobile geographic data collector.

10. The geographic data system of claim 7 wherein said electronic device is further for writing data to said data storage device.

11. The geographic data system of claim 10 wherein said data comprises data about an object which is at said geographic location.

12. The geographic data system of claim 10 wherein information about said geographic location is written to said data storage device by said electronic device

13. The geographic data system of claim 7 wherein said electronic device is further for converting a first coordinate system used to describe said geographic location to a second coordinate system used by said electronic device.

14. The geographic data system of claim 7 wherein said data storage device comprises a radio frequency identification (RFID) tag.

15. A method for accessing geographic information, said method comprising:
generating geographic position data describing a determined location; and
storing said geographic position data in a data storage device which is disposed at said determined location.

16. The method as described in claim 15 wherein said storing comprises:
storing said geographic position data in a radio frequency identification (RFID) tag.

17. The method as described in claim 15 further comprising:
placing a marker at said determined location and wherein said marker comprises said data storage device.

18. The method as described in claim 15 further comprising:
wirelessly accessing said geographic position data using a portable electronic device.

19. The method as described in claim 18 wherein said portable electronic device is selected from the group consisting of:
a handheld electronic device, an optical surveying component, an optical survey range pole, a real-time kinematic (RTK) roving receiver, a geographic information system (GIS) data collector, a three dimensional laser scanner, an electronic distance measuring (EDM) component, and a mobile geographic data collector.

20. The method as described in claim 18 further comprising:
using a first coordinate system to describe said determined location; and
using said portable electronic device to convert said first coordinate system to a second coordinate system.

21. The method as described in claim 15 further comprising:
generating information about an object that is at said geographic location; and
storing said information in said data storage device.
